(19) United States
(12) Patent Application Publication
(10) Pub. No.: US 2009/0124381 A1
(43) Pub. Date: May 14, 2009

(54) Ultimate football joystick

(76) Inventor: Howard Ellis Quillen, III, Bogalusa, LA (US)

Correspondence Address: HOWARD E. QUILLEN III, 1913 LASLEY, BOGALUSA, LA, 70427, US

(21) Appl. No.: 11/983,395

(22) Filed: Nov. 9, 2007

(51) Int. Cl. A63F 11/00; A63F 13/00

(52) U.S. Cl. 463/31; 463/47

(57) ABSTRACT

The controllers are designed specifically for play with football games on the Playstation and Xbox consoles. The player now has the ability to call plays without the opponent being able to see them. FIG. 1 is in similar form of current controllers on the market, while FIG. 2 is in the form of a wristband that quarter-backs wear in games that have their plays listed.

### FIELD OF PRODUCT

The UFGC is a new product being introduced into the video games' accessories arena. It is designed for play on the Sony Playstation consoles as well as the Microsoft Xbox 360 consoles with their #1 selling game each year, NFL Madden.

### BACKGROUND OF PRODUCT

The Sony Playstation currently uses the Dual Shock controller with the PS2 consoles and the SIXAXIS controller for the PS3. The Dual Shock controller for PS2 now includes two motors inside the handles. The buttons are now all analog which allows the controller to sense how much pressure is being applied. The SIXAXIS comes in the same form as the previous controllers but with added new features. Taking a cue from Microsoft and Nintendo, it now has a “home” button as well as four LEDs to indicate which player number each controller is. The SIXAXIS is wireless with a USB port on the back for charging. The most impressive addition is the tilt and motion detectors which give the controller some of the motion/gesture functionality of Nintendo's Wii controller. The Xbox 360 controller continues the evolution of the Xbox controller S. It comes in wired and wireless varieties. It has one set of shoulder buttons like the Playstation and one set of triggers like the GameCube & Dreamcast controllers—a best of both worlds kind of solution. There is also a headset/microphone connector on the front of the controller for Xbox Live use.

### DESCRIPTION OF THE PRESENT STATE OF THE ART

Sony and Microsoft both manufacture the controllers for their game systems. There are a few third party manufacturers of the controllers as well. Mad Catz provides controllers for both Sony and Microsoft which are basically the same as the original except for the NFL team logos personalized onto the controller. Psyclone Essentials also manufactures the PS2 controller. These controllers provide sufficient game play with the NFL Madden football game. However, when we asked Madden gamers what was the major challenge with the game today, 3 out of 4 say it's that their opponent can see their plays. This has been a challenge for the game since the very beginning. A few years ago, EA Sports introduced using the shoulder buttons on the controller to call a play not directly on the screen. So instead of the opponent being able to choose from 1 out of 3 plays, they have to guess which play was chosen out of 9 possibilities.

There isn't any other product on the market today that offers the features of the UFGC!

### PRODUCT SUMMARY

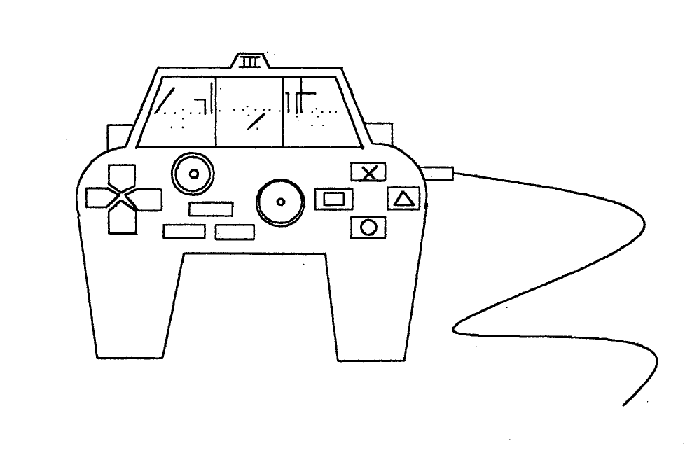

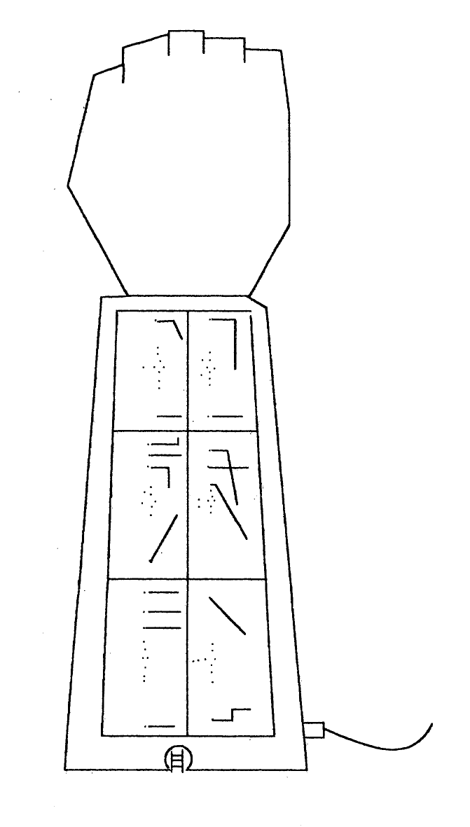

The UFGC will have the same form as the present controllers for both Sony and Microsoft, with some very new and improved features. Similar to Sega's Dreamcast controller, the UFGC will feature an LCD screen(FIG. 1.). Connected to this controller is a wristband controller also(FIG. 2). The wristband controller also has an LCD screen which allows for the player to view 30-40 offensive and defensive plays. This screen will be interfaced and programmed with NFL Madden so that a player can now view and call all their plays from the controller. The UFGC will take the play-calling screen from off the TV and put it in the hands of the players on their controllers. No longer does a Madden gamer have to worry if his opponent is “stealing’ his plays. The only thing viewable by the opponent on the TV screen will be the formation with which the player has chosen. This will give NFL Madden a more realistic football gaming experience.

Many players are un-easy about their opponents having the ability to view the play options they have. Not only does the UFGC eliminate this, it also eliminates gamers using this as an excuse for not playing well. It allows the player to feel more like a coach and at the same time will increase the overall enjoyment of the game.

We are diligently seeking assistance in finding a manufacturer to produce a prototype of this controller.

### BRIEF DESCRIPTION

The invention can be better understood with reference to the following drawings and description. The figures are not necessarily to scale, emphasis instead being placed upon the illustrating the principles of the invention.

FIG. 1 is a perspective view of the Ultimate Football Controller with the addition of the LCD-screen.

FIG. 2 is a perspective view of the wristband controller that works in conjunction with the hand-held controller.

### TEST RESULTS

From test surveys distributed in the Houston area, we find that 90% of Madden gamers across both game consoles agree that there is a need for a controller with the capabilities of the UFGC. Over 87% of those surveyed say that they would pay between $150-$200 for the UFGC, while over 95% say they would pay between $75-$150.

NFL Madden across all platforms continues to be the top-selling game each year, while not being introduced until the third quarter of the year.
August 2004=2.1 Million units sold
August 2005=2.5 Million units sold
August 2006=2 Million units sold (just first week)
August 2007=1.9 Million units sold

For the entire year, 2006, there were over 3.9 million units sold of NFL Madden on the PS2 and Xbox 360 alone.

We are open to pursuing additional market tests in the future with potential partners.

### Patent Status

Currently the UFGC is patent pending. The patent will protect the design, form and system components of the controller. The patent will exclude others from making, using, or selling the UFGC for a period of twenty years from the date of patent application filing, subject to payment of maintenance fees.

What is claimed is:

1) The addition of an LCD screen onto the current Sony Playstation 2 controller for play on both Playstation 2 & 3 and also Xbox 360. This LCD screen is fr play specifically with EA Sports football games; NFL Madden and NCAA College Football. This will allow the play-calling screen from each of these games to be shown on the controller now.

2) A wristband with an LCD screen having access to 30-40 offensive and defensive plays. This wristband will resemble the one that quarterbacks use today in the NFL, but with the addition of the LCD screen.

3) The addition of the LCD screen on the controller and the wristband is what is being claimed.
